(19) United States
(12) Patent Application Publication
(10) Pub. No.: US 2015/0010290 A1
(43) Pub. Date: Jan. 8, 2015

(54) IDENTIFYING MEDIA RELATING TO A PRIMARY MEDIA ON A PERSONAL VIDEO RECORDER

(71) Applicant: Telefonaktiebolaget L M Ericsson (Publ), Stockholm (SE)

(72) Inventors: Donald JOONG, Montreal (CA); Kamel HAMARD, Montreal (CA)

(21) Appl. No.: 13/933,868

(22) Filed: Jul. 2, 2013

(51) Int. Cl. H04N 21/433; H04N 21/4147

(52) U.S. Cl. CPC H04N 21/4334; H04N 21/4147
USPC 386/248

(57) ABSTRACT

A method and apparatus for presenting media content by identifying media content relating to a primary media recordable on a Personal Video Recorder, PVR. A PVR receives an identifier of the primary media, and identifies secondary media available at a media source. The primary media is recordable on the PVR, and the identified secondary media is different than the primary media and is associated with the identifier of the primary media.

### CROSS-REFERENCE TO RELATED APPLICATIONS

Not applicable.

### TECHNICAL FIELD

The present invention relates to methods and apparatus for presenting media content to end users, and more specifically, to identifying media relating to a primary media at a personal video recorder.

### BACKGROUND

Multimedia entertainment systems include multiple components interconnected to provide the audio and visual information to a user. In addition to a display, e.g., television or projector, systems include a separate set top box that may include a tuner and service provider-specific signal processing and subscription functionality. Systems may also include components for recording media for later playback. Such recording components include a personal video recorder (PVR), which is a device or application software for recording media, usually in digital format, onto a storage medium such as a disk drive. A PVR can be integrated with the tuner.

When a user wishes to record video content on a PVR system, the user instructs the PVR system to record a program selected from an electronic programming guide (EPG). The PVR system receives the instructions, which include an identification number of the selected program, and schedules the recording of the selected program.

The PVR system often stores and associates the EPG information to the recorded programming, and the recorded EPG information is later retrieved by the end users who wish to browse their library of recordings and/or retrieve a recording. The PVR does not, however, record additional content related to the selected program. Additional content can include, for example, promotional material that may be of interest and informative to the user.

In addition to recording EPG information, conventional systems do not provide a capability of associating additional content with the selected program and recording the associated content from a channel on which the selected program is shown.

### SUMMARY

The present invention relates to a method and apparatus for identifying media content relating to a primary media recordable on a Personal Video Recorder, PVR. In accordance with one embodiment, a method for identifying media content relating to a primary media recordable on a Personal Video Recorder, PVR, includes receiving an identifier of the primary media and identifying secondary media available at a media source. The primary media is recordable on the PVR and the identified secondary media is different than the primary media and is associated with the identifier of the primary media.

In accordance with an aspect of this embodiment, the method includes recording the identified secondary media based on a condition. In accordance with another aspect of this embodiment, the condition is a user-selected option to record the identified secondary media. In accordance with yet another aspect of this embodiment, the condition is a quantity of requested secondary media. In accordance with still another aspect of this embodiment, the method includes recording the primary media based on a second condition that includes a user-selected option associated with the identified secondary media. In accordance with another aspect of this embodiment, the method includes recording the identified secondary media if the secondary media has not been previously recorded on the PVR. In accordance with yet another aspect of this embodiment, the method includes monitoring a media stream for secondary media, wherein the media stream is the media source. In accordance with still another aspect of this embodiment, the method includes parsing metadata of the secondary media and determining that the secondary media is associated with the identifier of the primary media based on the parsed metadata. In accordance with another aspect of this embodiment, the identifying the secondary media includes parsing the identifier of the primary media to determine a location of the secondary media, retrieving the secondary media from the determined location, and recording the retrieved secondary media. In accordance with yet another aspect of this embodiment, the primary media is from a first media source different than the media source of the secondary media.

In accordance with another embodiment, a Personal Video Recorder, PVR, for identifying media content relating to a primary media includes an interface and a processor. The interface is configured to receive an identifier of the primary media. The processor is in communication with the interface and configured to identify secondary media available at a media source, wherein the identified secondary media is different than the primary media and is associated with the identifier of the primary media.

In accordance with another aspect of this embodiment, the processor is further configured to record the identified secondary media based on a condition. In accordance with still another aspect of this embodiment, the processor is further configured to record the identified secondary media if the secondary media has not been previously recorded. In accordance with yet another aspect of this embodiment, the apparatus further includes a second interface in communication with the processor. The second interface is configured to receive a media stream that is different than the media source. The processor is further configured to monitor the media stream for secondary media. In accordance with still another aspect of this embodiment, the processor is further configured to parse metadata of the secondary media and determine whether the secondary media is associated with the identifier of the primary media based on the metadata. In accordance with another aspect of this embodiment, the processor is further configured to parse the identifier of the primary media to determine a location of the secondary media, retrieve the secondary media from the determined location, and record the retrieved secondary media. In accordance with yet another aspect of this embodiment, the apparatus further includes a first media interface in communication with the processor and a second media interface in communication with the processor. The first media interface is configured to receive the primary media. The second media interface is configured to receive the secondary media. The second media interface is different than the first media interface.

In accordance with another embodiment, an apparatus for providing media for a Personal Video Recorder, PVR, has a processor and a serializer. The processor is configured to determine an identifier of a primary media. The serializer is in communication with the processor and is configured to add the determined identifier to a secondary media different than the primary media and associated with the primary media.

In accordance with another aspect of this embodiment, the apparatus further includes a media interface in communication with the serializer and configured to stream the serialized identifier and secondary media as streamed media. In accordance with yet another aspect of this embodiment, the apparatus further includes a media interface in communication with the serializer. The media interface is configured to provide the secondary media in response to a request that includes the identifier of the primary media. In accordance with still another aspect of this embodiment, the processor is further configured to determine a second identifier of the secondary media, and the serializer is further configured to add the determined second identifier to the secondary media. In accordance with another aspect of this embodiment, the processor is further configured to determine the second identifier of the secondary media, and the apparatus further includes a media interface in communication with the serializer. The media interface is configured to provide the secondary media in response to a request that includes the second identifier of the secondary media.

### BRIEF DESCRIPTION OF THE DRAWINGS

FIG. 1 is a block diagram of a multimedia system constructed in accordance with principles of the present invention;

FIG. 2 is a block diagram of a gateway constructed in accordance with the principles of the present invention;

FIG. 3 is a block diagram of a set top box constructed in accordance with the principles of the present invention;

FIG. 4 is a flow chart of an exemplary process of associating a secondary media with a primary media and storing the secondary media in accordance with principles of the present invention;

FIG. 5 is a flow chart of an exemplary process of identifying the secondary media in accordance with principles of the present invention;

FIG. 6 is a flow chart of another exemplary process of identifying the secondary media in accordance with principles of the present invention;

FIG. 7 is a block diagram of a transport stream in accordance with the principles of the present invention; and

FIG. 8 is a block diagram of metadata of the primary media and/or the secondary media in accordance with the principles of the present invention.

### DETAILED DESCRIPTION

Before describing in detail exemplary embodiments that are in accordance with the present invention, it is noted that the embodiments reside primarily in combinations of apparatus components and processing steps related to identifying and storing secondary media associated with primary media recordable on a personal video recorder (PVR). Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

In embodiments described herein, the joining term, “in communication with” and “connected to,” and the like, may be used to indicate electrical and data communication, which may be accomplished by physical contact, induction, electromagnetic radiation, radio signaling, infrared signaling or optical signaling, for example. The above methods of achieving electrical and data communication are non-limiting and mentioned only for illustration. One having ordinary skill in the art will appreciate that multiple components may interoperate and modifications and variations are possible of achieving the electrical and data communication.

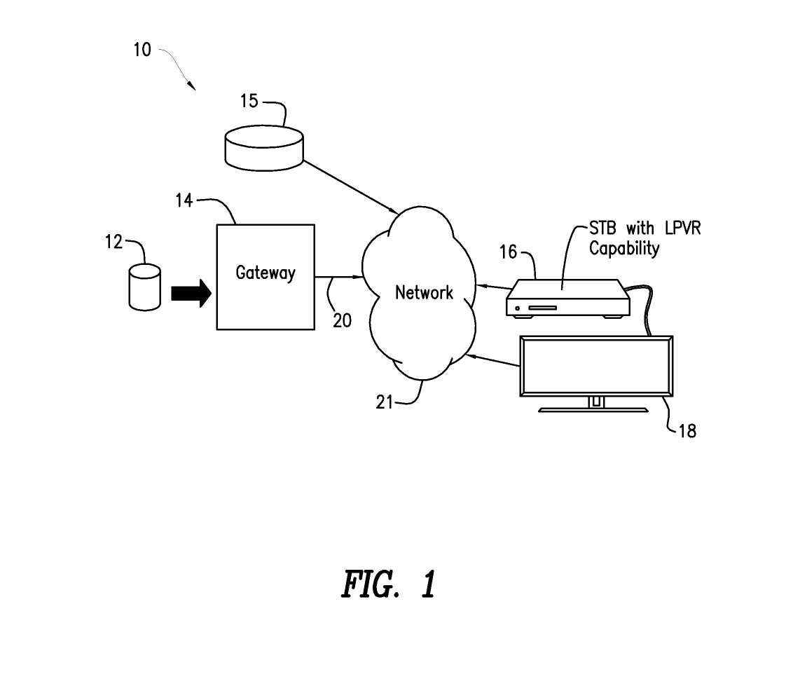

Referring to the drawing figures in which like reference designators refer to like elements, FIG. 1 shows a multimedia system 10 according to an exemplary embodiment of the present invention. The system 10 includes a head-end 12 in communication with a gateway 14. The head-end 12 receives television signals, e.g., programming signals, and processes the signals for distribution. The gateway 14 is in communication with the head-end 12 and provides subscriber-level functionality including, for example, Internet protocol television (IPTV) service. The gateway 14 is in communication with a set top box 16 and transmits multimedia data on a transport stream 20 to a set top box 16. The set top box 16 provides a user subscriber multimedia content and electronic programming functionality, and may be capable of live-play video recording (LPVR). The set top box 16 is also referred to herein as a PVR, it being understood that the invention is not limited to a device that must physically reside on a television or display device. The set top box 16 is in communication with a display 18 that is arranged to show content to a user. The set top box 16 is also in communication with a studio promotion server 15, which provides promotional media (referred to herein as “secondary media”) to the set top box 16. According to some exemplary embodiments of the present invention, the set top box 16 may receive media from one or more media sources including the head end 12, the gateway 14 (via transport stream 20) and the studio promotion server 15.

The components described hereinabove may be in communication with each other and other components over a network 21. According to some exemplary embodiments, the network 21 may be a local area network (LAN), wide area network (WAN), the Internet, combination of the above or other form, or direct, packetized or circuit switched communication.

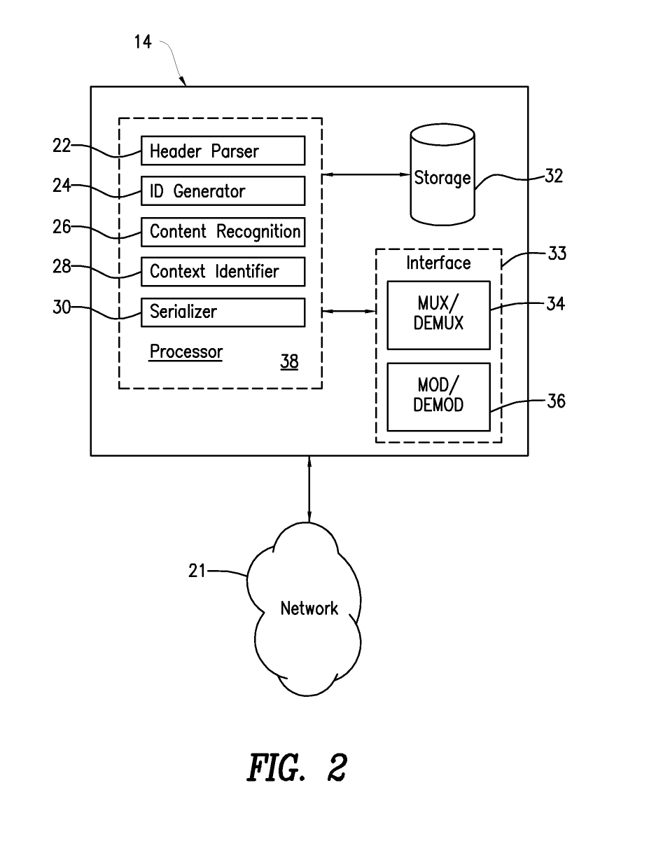

An exemplary gateway 14 is disclosed with reference to FIG. 2. The gateway 14 includes a header parser 22, an identification (ID) generator 24, a content recognition module 26, a context identifier 28 and a serializer 30. The gateway 14 includes storage 32 and a media interface 33. The media interface 33 includes a multiplexer/demultiplexer (MUX/DEMUX) 34 in communication with a modulator/demodulator (MOD/DEMOD) 36. Although the media interface 33 in the exemplary embodiment is described as including the MUX/DEMUX 34 and MOD/DEMOD 36, one having ordinary skill in the art will appreciate that the media interface 33 may include fewer or additional other components for achieving a media interface. According to some exemplary embodiments, the gateway 14 may be a middleware server including, for example, a TV Middleware Server.

The header parser 22 parses a data stream and/or packet headers for data including metadata and parameter listings. ID generator 24 generates an identification that may be assigned to programming and promotional material. Content recognition module 26 analyzes video content, audio content and/or metadata of programming and/or promotional material, and determines content information (e.g., actors, music, length) of the programming and/or promotional material. Context identifier 28 analyzes video content, audio content and/or metadata of programming and/or promotional material, and determines context information (genre, time period) of the programming and/or promotional material. The content and context information may be saved as metadata or in storage 32 as relating to the programming and/or promotional material. The metadata may be saved as header or trailer information that is combined or serialized by the serializer 30 to the programming and/or promotional material (primary or secondary media). According to some exemplary embodiments, aspects of the gateway 14 may be implemented in hardware on a processor 38 or as a combination of hardware and software. Code to implement aspects of gateway 14 including the functions of the processor 38 can be stored in storage 32.

The MUX/DEMUX 34 provides multiplexing and demultiplexing functionality for signals transmitted and received by the interface 33 of the gateway 14. The MOD/DEMOD 36 handles actual signal modulation and demodulation of the signals transmitted and received by the interface 33. The gateway 14, studio promotion server 15, set top box 16 and display 18 are in communication with a network 21, which may be configured to provide broadcast, multicast and/or unicast transmissions to nodes on the network 21.

According to some exemplary embodiments, the gateway 14 may include one or more media interfaces 33 wherein a first media interface 33 provides transmission of primary media and a second, different media interface 33 provides transmission of secondary media. According to some exemplary embodiments, the gateway 14 may include a packetizer (not shown), which packages the multimedia data into packets for transmission from the media interface on a packet network such as the Internet.

According to some exemplary embodiments, the gateway 14 may provide primary or secondary media in response to a request including a media ID. The media ID may unique identify or otherwise aid in identification of the primary or secondary media, which may have a primary media ID or a secondary media ID, respectively. Similarly, according to other exemplary embodiments, the gateway 14 may provide the primary media in response to a request including the secondary media ID, and the gateway 14 may provide the secondary media in response to a request including the primary media ID.

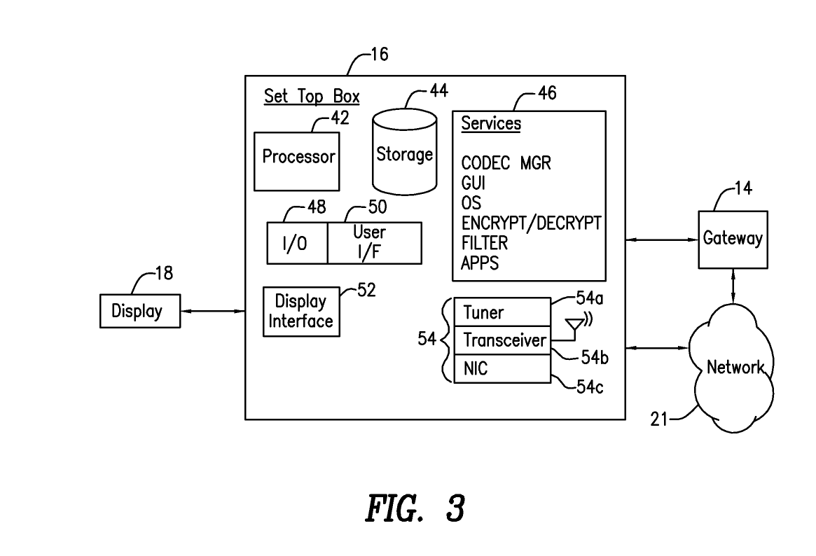

An exemplary set top box 16 is described with reference to FIG. 3. The set top box 16 includes a processor 42 and storage 44. A services module 46 provides subscriber functionality and provider functionality for the set top box 16 including, for example CODEC management, a graphical user interface (GUI), an operating system (OS), encryption/decryption services, program filtering and applications, for example. As used here, a CODEC refers to a device or program for encoding and/or decoding a digital data stream or signal. Set top box 16 includes input/output interface 48, which may implement a user interface 50 for a subscriber to enter data, modify settings, or input selections, for example into the set top box 16. Set top box 16 includes a display interface 52, which allows connection of the set top box 16 to an external display 18. A multimedia interface 54 provides signaling between the set top box 16 and a broadcast provider operating the gateway 14 and a network 21. The multimedia interface 54 may include more than one interface type such as a tuner 54a, transceiver 54b and a network interface card (NIC) 54c, for example. According to some exemplary embodiments, the network 21 may be a local area network (LAN), wide area network (WAN) and the INTERNET. According to some exemplary embodiments, aspects of the set top box 16 may be implemented in hardware on the processor 42 or as a combination of hardware and software. Code to implement aspects of set top box 16 including the functions of the processor 42 can be stored in storage 44. According to some exemplary embodiments, the storage 44 may be used for storing recorded media such as primary media and secondary media, and the set top box 16 may be referred to as a Personal Video Recorder (PVR).

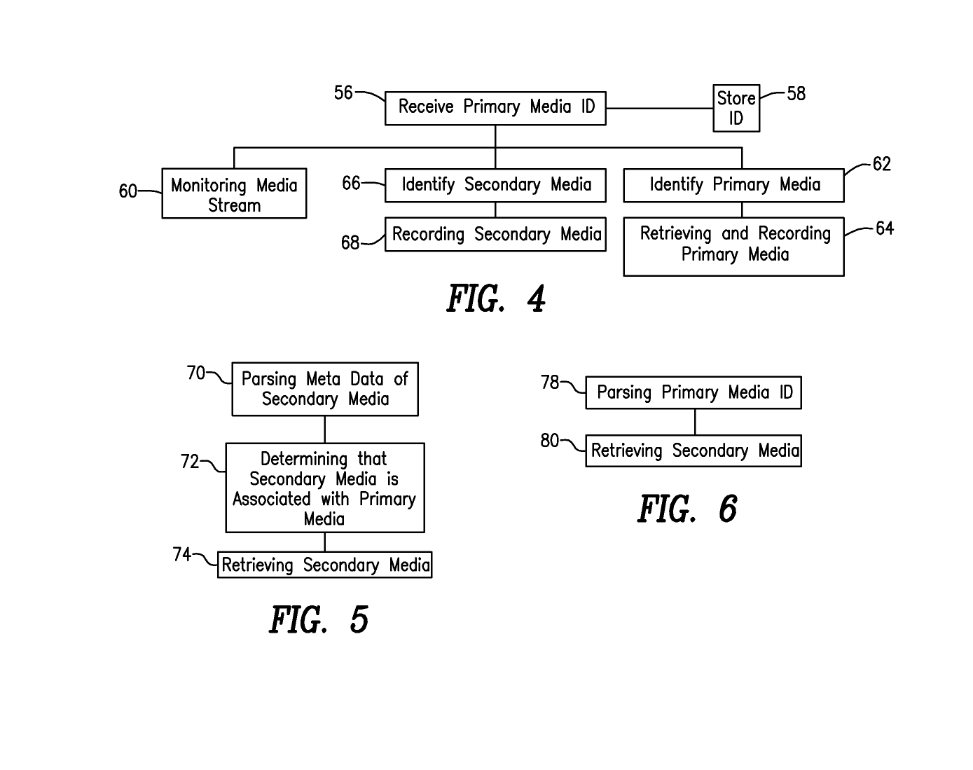

An exemplary process for associating a secondary media with a primary media and storing the secondary media is described with reference to FIG. 4. A set top box 16 receives a primary media ID (block 56). The primary media ID identifies a primary media, which may be a user selection listed in an electronic programming guide (EPG) and accessed through a user interface or from subscription data provided by the service provider, for example. The program is recordable to the PVR and is referred to herein as primary media. The primary media is multimedia content that is principally shown during a broadcast period or time slot. The primary media ID is stored in storage 44 (block 58). The set top box 16 monitors a media stream for multimedia content (block 60), which includes primary media and secondary media content. The transport stream may be the transport stream 20 or any other source of streaming multimedia data. The primary media is identified (block 62). According to one embodiment, the primary media may be identified using the primary media ID received above. The identified primary media is retrieved and recorded at the set top box 16 (block 64). A secondary media is identified (block 66). The secondary media is multimedia that is associated to the primary media and includes, for example, promotional material for the primary media, e.g., a trailer, teaser or preview. Processes to identify the secondary media are described in further detail with respect to FIGS. 5-8 below. The identified secondary media is recorded at the set top box 16 (block 68).

According to some exemplary embodiments, a pointer or address to the secondary media may be recorded at the set top box 16. The pointer or address may be, for example, a uniform resource identifier (URI) that indicates a location where the secondary media may be retrieved or streamed. Furthermore, the PVR may include functionality to recognize that the same media (either primary or secondary media) may be shown multiple times and the PVR can choose one of the multiple instances that is earliest in time, highest in quality, or does not interfere with a conflicting another scheduled recording (in the event the set top box 16 is not capable of simultaneous recordings). According to still other exemplary embodiments, the PVR may be configured to record a predetermined or user-selectable number of secondary media.

According to some exemplary embodiments, the primary media is recorded after a user has further made an additional selection to confirm recording the primary media after the user has had an opportunity, for example, to review at least one secondary media.

An exemplary process for identifying the secondary media is described with reference to FIG. 5. The set top box 16 parses metadata of secondary media (block 70). Specifically, to parse the metadata, the processor 42 and/or services 46 operate to analyze the secondary media to identify portions of segments of the secondary media as metadata. The set top box 16 may obtain the secondary media from the media stream or, according to some exemplary embodiments, from polling a media source or from subscription data provided by the service provider. The metadata may be, for example, in a header or trailer of the secondary media and may include parameter listings. The format of the secondary media and the metadata therein may be defined by an established messaging standard or previously agreed upon message or streaming format. According to some exemplary embodiments, the metadata may explicitly include a reference ID. According to other exemplary embodiments, the metadata may include a hash or other value or identification value that is derived from or used to derive a reference ID. According to other exemplary embodiments, the metadata may include a series ID that is associated to the primary media ID. A series ID may identify a series, which is a program or show that includes periodically recurring segments of content or episodes that comprise the series. According to some exemplary embodiments, the primary media ID may be associated with an episode of a series. According to other exemplary embodiments, the primary media ID may be associated with an entire series.

A determination is made whether the secondary media is associated with the primary media based on the parsed metadata of the secondary media (block 72). If, for example, the explicit or derived reference ID that is parsed from the metadata of the secondary media is equal to or derived from the primary reference ID, it is determined that the secondary media is associated with the primary media. The secondary media associated with the primary media is retrieved, for example, from the media stream or from a location identified in the secondary media ID or an associated location, e.g., URI (block 74).

Another exemplary process for identifying the secondary media is described with reference to FIG. 6. The primary media ID is parsed (block 78). Similar to above, the processor 42 and/or services 46 operate to analyze the primary media ID to identify information therein. According to some exemplary embodiments, the primary media ID includes one or more segments that may be parsed and/or combined to identify the secondary media or form the secondary media ID. According to other exemplary embodiments, the one or more segments may be used to calculate the secondary media ID. For example, the primary media ID or segments thereof may be a seed value of a hash function which produces the secondary media ID. Once the secondary media ID is determined, the secondary media is retrieved (block 80), for example, from the media stream or from a location identified in the secondary media ID or associated location.

It will be appreciated that the primary media and the secondary media maybe retrieved from same or different media streams/locations in blocks 62, 72 and 80.

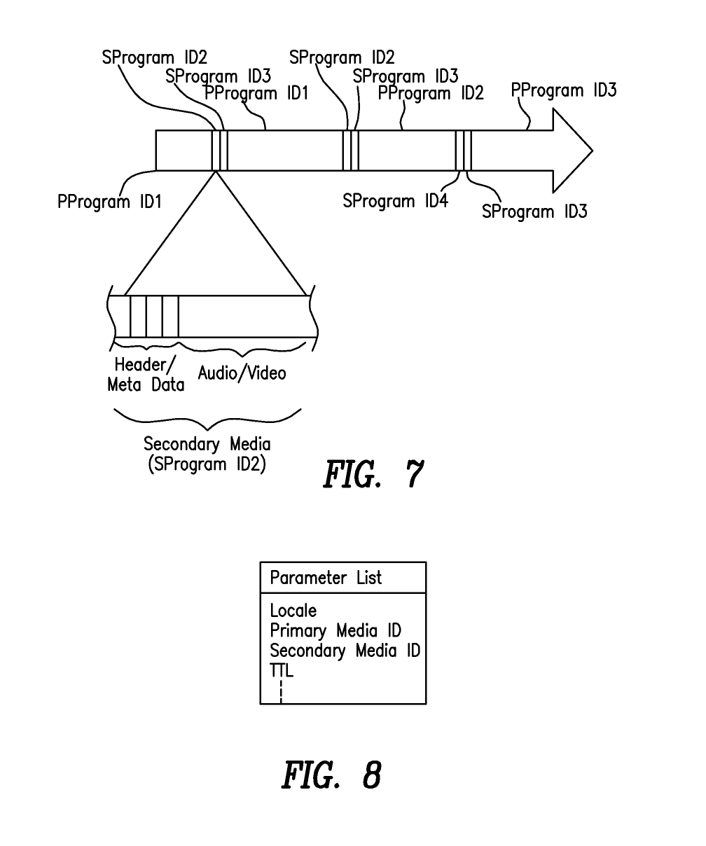

An exemplary transport stream is described with reference to FIG. 7. The transport stream 20 includes a first primary media, which is identified by a primary media ID (PProgramID1), which may be divided into a first and second segment by secondary media identified by a secondary media ID (SProgramID2) and a secondary media ID (SProgramID3). The second segment of primary media (PProgramID1) may also be separated from a second primary media, which is identified by a primary media ID (PProgramID2), by secondary media identified by a secondary media ID (SProgramID2) and a secondary media ID (SProgramID3). The second primary media, which is identified by a primary media ID (PProgramID2), is separated from a third primary media, which is identified by a primary media ID (PProgramID3), by secondary media identified by a secondary media ID (SProgramID4) and secondary media ID (SProgramID3). According to some exemplary embodiments, secondary media identified by secondary media ID (SProgram ID2) may be associated with or relate to the second primary media identified by primary media ID (PProgram ID2). Similarly, secondary media identified by secondary media ID (SProgram ID3) may be associated with or relate to the third primary media identified by primary media ID (PProgram ID3). FIG. 7 shows an expanded portion of secondary media (SProgramID2) that shows header/metadata included with the audio and video content of the secondary media.

FIG. 8 is a diagram of an exemplary metadata of the primary media and/or the secondary media according to an exemplary embodiment of the present invention. The metadata includes a parameter list including a locale, the primary media ID, the secondary media ID, and a time to live (TTL), for example. The locale may specify a language or region of the relevant primary or secondary media. The TTL may specify a promotional air date (expiration) of the primary or secondary media, e.g., in a teaser campaign. It will be appreciated that if the metadata is for the primary media, the secondary media ID identifies secondary media associated with the primary media. Similarly, if the metadata is for the secondary media, the primary media ID identifies primary media associated with the secondary media. It will be further appreciated that according to exemplary embodiments, the primary media and the secondary media may be associated in a one-to-one relationship, a one-to-many relationship, a many-to-one relationship, or a many-to-many relationship.

It will be appreciated that the parameter list may include fewer or more data. It will also be appreciated that the metadata may be a parameter list, a structured data header, or binary data, for example.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for identifying media content relating to a primary media recordable on a Personal Video Recorder, PVR, the method comprising:
receiving an identifier of the primary media, the primary media being recordable on the PVR; and
identifying secondary media available at a media source, the identified secondary media being different than the primary media and being associated with the identifier of the primary media.

2. The method of claim 1, further comprising:
recording the identified secondary media based on a condition.

3. The method of claim 2, wherein the condition is a user-selected option to record the identified secondary media.

4. The method of claim 2, wherein the condition is a quantity of requested secondary media.

5. The method of claim 1, further comprising:
recording the primary media based on a second condition, the second condition including a user-selected option associated with the identified secondary media.

6. The method of claim 1, further comprising:
recording the identified secondary media if the secondary media has not been previously recorded on the PVR.

7. The method of claim 1, further comprising:
monitoring a media stream for secondary media, the media stream being the media source.

8. The method of claim 1, wherein identifying the secondary media comprises:
parsing metadata of the secondary media; and
determining that the secondary media is associated with the identifier of the primary media based on the parsed metadata.

9. The method of claim 1, wherein the identifying the secondary media comprises:
parsing the identifier of the primary media to determine a location of the secondary media;
retrieving the secondary media from the determined location; and
recording the retrieved secondary media.

10. The method of claim 1, wherein the primary media is from a first media source different than the media source of the secondary media.

11. A Personal Video Recorder, PVR, for identifying media content relating to a primary media, the PVR comprising:
an interface configured to receive an identifier of the primary media; and
a processor in communication with the interface and configured to identify secondary media available at a media source, the identified secondary media being different than the primary media and being associated with the identifier of the primary media.

12. The apparatus of claim 11, wherein the processor is further configured to:
record the identified secondary media based on a condition.

13. The apparatus of claim 11, wherein the processor is further configured to:
record the identified secondary media if the secondary media has not been previously recorded.

14. The apparatus of claim 11, further comprising:
a second interface in communication with the processor and configured to receive a media stream, the media stream being the media source, the processor further configured to:
monitor the media stream for secondary media.

15. The apparatus of claim 11, wherein the processor is further configured to:
parse metadata of the secondary media; and
determine whether the secondary media is associated with the identifier of the primary media based on the metadata.

16. The apparatus of claim 11, wherein the processor is further configured to:
parse the identifier of the primary media to determine a location of the secondary media;
retrieve the secondary media from the determined location; and
record the retrieved secondary media.

17. The apparatus of claim 11, further comprising:
a first media interface in communication with the processor and configured to receive the primary media; and
a second media interface in communication with the processor and configured to receive the secondary media, the second media interface being different than the first media interface.

18. An apparatus for providing media for a Personal Video Recorder, PVR, the apparatus comprising:
a processor configured to determine an identifier of a primary media; and
a serializer in communication with the processor and configured to add the determined identifier to a secondary media different than the primary media and associated with the primary media.

19. The apparatus of claim 18, further comprising:
a media interface in communication with the serializer and configured to stream the serialized identifier and secondary media as streamed media.

20. The apparatus of claim 18, further comprising:
a media interface in communication with the serializer and configured to provide the secondary media in response to a request, the request including the identifier of the primary media.

21. The apparatus of claim 18, wherein:
the processor is further configured to determine a second identifier of the secondary media, and
the serializer is further configured to add the determined second identifier to the secondary media.

22. The apparatus of claim 18, wherein the processor is further configured to determine the second identifier of the secondary media, the apparatus further comprising:
a media interface in communication with the serializer and configured to provide the secondary media in response to a request, the request including the second identifier of the secondary media.
